(19) United States
(12) Patent Application Publication
(10) Pub. No.: US 2001/0045061 A1
(43) Pub. Date: Nov. 29, 2001

(54) Fuel processor and systems and devices containing the same

(75) Inventors: David J. Edlund, Bend, OR (US); William A. Pledger, Sisters, OR (US); Todd Studebaker, Bend, OR (US)

Correspondence Address: Kolisch, Hartwell, Dickinson,, McCormack & Heuser, 520 S.W. Yamhill Street, Suite 200, Portland, OR, 97204, US

(73) Assignee: Ida Tech, L.L.C.

(21) Appl. No.: 09/802,361

(22) Filed: Mar. 8, 2001

Related U.S. Application Data
(60) Provisional application No. 60/188,993, filed on Mar. 13, 2000.

(51) Int. Cl. B01J 7/00; C10J 3/00

(52) U.S. Cl. 48/76; 48/61

(57) ABSTRACT

Fuel processors and fuel processing and fuel cell systems containing the same. The fuel processor is adapted to produce a product hydrogen stream from a feed stream, such as at least one of water and a carbon-containing feedstock, which may be one or more hydrocarbons or alcohols. In some embodiments, the fuel processor is a steam reformer containing a separation region in which the reformate stream is purified using a pressure-driven separation process. In some embodiments, the fuel processor includes a filter assembly adapted to remove particulates from the reformate stream prior to delivery to the separation region. In some embodiments, the fuel processor contains one or more cartridge-based components to facilitate easier removal and replacement of these components. In some embodiments, the fuel processor includes an air delivery system adapted to regulate the operating temperature of the fuel processor.

### RELATED APPLICATION

This application claims priority to U.S. Provisional Patent Application Ser. No. 60/188,993, which was filed on Mar. 13, 2000, is entitled “Fuel Processor,” and the complete disclosure of which is hereby incorporated by reference.

### FIELD OF THE INVENTION

The present invention relates generally to fuel processing systems, which contain a fuel processor adapted to produce hydrogen gas, to fuel cell systems that include a fuel processor and a fuel cell stack, and more particularly to an improved fuel processor for use in fuel processing systems, fuel cell systems, and devices incorporating the same.

### BACKGROUND OF THE INVENTION

Fuel processing systems include a fuel processor that produces hydrogen gas or hydrogen-rich gas from common fuels such as a carbon-containing feedstock. Fuel cell systems include a fuel processor and a fuel cell stack adapted to produce an electric current from the hydrogen gas. The hydrogen or hydrogen-rich gas produced by the fuel processor is fed to the anode region of the fuel cell stack, air is fed to the cathode region of the fuel cell stack, and an electric current is generated.

### SUMMARY OF THE INVENTION

The present invention is directed to fuel processors and fuel processing and fuel cell systems containing a fuel processor, and to devices containing the same. The fuel processor is adapted to produce a product hydrogen stream from a feed stream, such as at least one of water and a carbon-containing feedstock, which may be one or more hydrocarbons or alcohols. In some embodiments, the fuel processor is a steam reformer containing a separation region in which the reformate stream is purified using a pressure-driven separation process. In some embodiments, the fuel processor includes a filter assembly adapted to remove particulates from the reformate stream prior to delivery to the separation region. In some embodiments, the fuel processor contains one or more cartridge-based components to facilitate easier removal and replacement of these components. In some embodiments, the fuel processor includes an air delivery system adapted to regulate the operating temperature of the fuel processor.

### BRIEF DESCRIPTION OF THE DRAWINGS

FIG. 1 is a schematic diagram of a fuel cell system containing a fuel processor according to the present invention.

FIG. 2 is a schematic diagram of another embodiment of the fuel cell system of FIG. 1.

FIG. 3 is a schematic diagram of a fuel processor suitable for use in the fuel cell systems of FIGS. 1 and 2.

FIG. 4 is a schematic diagram of another embodiment of the fuel processor of FIG. 3.

FIG. 5 is a schematic diagram of another embodiment of the fuel processor according to the present invention and including a filter assembly.

FIG. 6 is a cross-sectional view of a fuel processor containing a filter assembly.

FIG. 7 is an exploded isometric view of a membrane module suitable for use in fuel processors according to the present invention.

FIG. 8 is an exploded isometric view of a membrane envelope suitable for use in the membrane module of FIG. 7.

FIG. 9 is a schematic diagram of a cartridge-based fuel processor according to the present invention.

FIG. 10 is a cross-sectional view of another cartridge-based fuel processor according to the present invention.

FIG. 11 is a cross-sectional view of another cartridge-based fuel processor according to the present invention.

FIG. 12 is a cross-sectional view of another cartridge-based fuel processor according to the present invention.

FIG. 13 is a cross-sectional view of another cartridge-based fuel processor according to the present invention.

FIG. 14 is a cross-sectional view of another cartridge-based fuel processor according to the present invention.

### DETAILED DESCRIPTION AND BEST MODE OF THE INVENTION

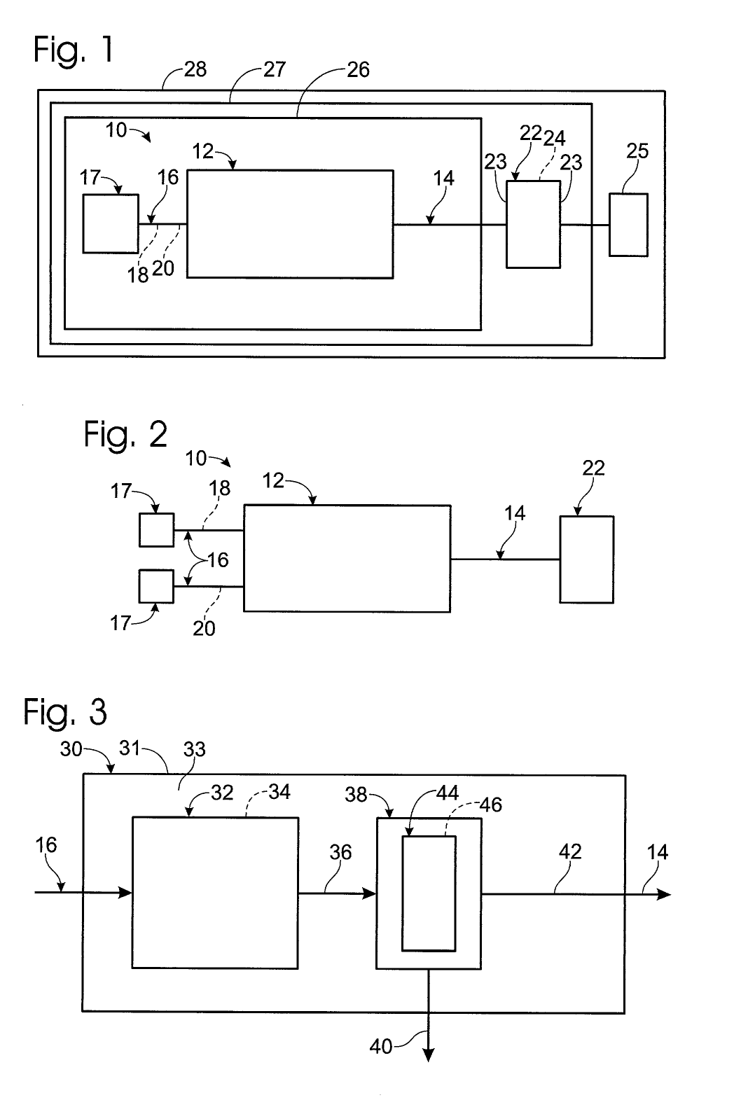

A fuel cell system according to the present invention is shown in FIG. 1 and generally indicated at 10. System 10 includes at least one fuel processor 12 and at least one fuel cell stack 22. Fuel processor 12 is adapted to produce a product hydrogen stream 14 containing hydrogen gas from a feed stream 16 containing a feedstock. The fuel cell stack is adapted to produce an electric current from the portion of product hydrogen stream 14 delivered thereto. In the illustrated embodiment, a single fuel processor 12 and a single fuel cell stack 22 are shown and described, however, it should be understood that more than one of either or both of these components may be used. It should also be understood that these components have been schematically illustrated and that the fuel cell system may include additional components that are not specifically illustrated in the figures, such as feed pumps, air delivery systems, heat exchangers, heating assemblies and the like.

Fuel processor 12 produces hydrogen gas through any suitable mechanism. Examples of suitable mechanisms include steam reforming and autothermal reforming, in which reforming catalysts are used to produce hydrogen gas from a feed stream containing a carbon-containing feedstock and water. Other suitable mechanisms for producing hydrogen gas include pyrrolysis and catalytic partial oxidation of a carbon-containing feedstock, in which case the feed stream does not contain water. Still another suitable mechanism for producing hydrogen gas is electrolysis, in which case the feedstock is water.

For purposes of illustration, the following discussion will describe fuel processor 12 as a steam reformer adapted to receive a feed stream 16 containing a carbon-containing feedstock 18 and water 20. However, it is within the scope of the invention that the fuel processor 12 may take other forms, as discussed above.

Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream 16 may be delivered to fuel processor 12 via any suitable mechanism. Although only a single feed stream 16 is shown in FIG. 1, it should be understood that more than one stream 16 may be used and that these streams may contain the same or different components. When carbon-containing feedstock 18 is miscible with water, the feedstock is typically delivered with the water component of feed stream 16, such as shown in FIG. 1. When the carbon-containing feedstock is immiscible or only slightly miscible with water, these components are typically delivered to fuel processor 12 in separate streams, such as shown in FIG. 2.

In FIGS. 1 and 2, feed stream 16 is shown being delivered to fuel processor 12 by a feed stream delivery system 17. Delivery system 17 includes any suitable mechanism, device, or combination thereof that delivers the feed stream to fuel processor 12. For example, the delivery system may include one or more pumps that deliver the components of stream 16 from a supply. Additionally, or alternatively, system 17 may include a valve assembly adapted to regulate the flow of the components from a pressurized supply. The supplies may be located external of the fuel cell system, or may be contained within or adjacent the system.

Fuel cell stack 22 contains at least one, and typically multiple, fuel cells 24 adapted to produce an electric current from the portion of the product hydrogen stream 14 delivered thereto. This electric current may be used to satisfy the energy demands, or applied load, of an associated energy-consuming device 25. Illustrative examples of devices 25 include, but should not be limited to, a motor vehicle, recreational vehicle, boat, tools, lights or lighting assemblies, appliances (such as household or other appliances), household, signaling or communication equipment, etc. It should be understood that device 25 is schematically illustrated in FIG. 1 and is meant to represent one or more devices or collection of devices that are adapted to draw electric current from the fuel cell system. A fuel cell stack typically includes multiple fuel cells joined together between common end plates 23, which contain fluid delivery/removal conduits (not shown). Examples of suitable fuel cells include proton exchange membrane (PEM) fuel cells and alkaline fuel cells. Fuel cell stack 22 may receive all of product hydrogen stream 14. Some or all of stream 14 may additionally, or alternatively, be delivered, via a suitable conduit, for use in another hydrogen-consuming process, burned for fuel or heat, or stored for later use.

Fuel processor 12 is any suitable device that produces hydrogen gas. Preferably, the fuel processor is adapted to produce substantially pure hydrogen gas, and even more preferably, the fuel processor is adapted to produce pure hydrogen gas. For the purposes of the present invention, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 5,997,594 and 5,861,137, pending U.S. patent application Ser. No. 09/291,447, which was filed on Apr. 13, 1999, and is entitled “Fuel Processing System,” and U.S. Provisional Patent Application Ser. No. 60/188,993, which was filed on Mar. 13, 2000 and is entitled “Fuel Processor,” each of which is incorporated by reference in its entirety for all purposes.

An example of a suitable fuel processor 12 is a steam reformer. An example of a suitable steam reformer is shown in FIG. 3 and indicated generally at 30. Reformer 30 includes a reforming, or hydrogen-producing, region 32 that includes a steam reforming catalyst 34. Alternatively, reformer 30 may be an autothermal reformer that includes an autothermal reforming catalyst. In reforming region 32, a reformate stream 36 is produced from the water and carbon-containing feedstock forming feed stream 16. The reformate stream typically contains hydrogen gas and impurities, and therefore is delivered to a separation region, or purification region, 38, where the hydrogen gas is purified. In separation region 38, the hydrogen-containing stream is separated into one or more byproduct streams, which are collectively illustrated at 40, and a hydrogen-rich stream 42 by any suitable pressure-driven separation process. In FIG. 3, hydrogen-rich stream 42 is shown forming product hydrogen stream 14.

An example of a suitable structure for use in separation region 38 is a membrane module 44, which contains one or more hydrogen permeable metal membranes 46. Examples of suitable membrane modules formed from a plurality of hydrogen-selective metal membranes are disclosed in U.S. patent application Ser. No. 09/291,447, which was filed on Apr. 13, 1999, is entitled “Fuel Processing System,” and the complete disclosure of which is hereby incorporated by reference in its entirety for all purposes. In that application, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in U.S. patent application Ser. No. 09/618,866, which was filed on Jul. 19, 2000 and is entitled “Hydrogen-Permeable Metal Membrane and Method for Producing the Same,” the complete disclosure of which is hereby incorporated by reference in its entirety for all purposes. Other suitable fuel processors are also disclosed in the incorporated patent applications.

The thin, planar, hydrogen-permeable membranes are preferably composed of palladium alloys, most especially palladium with 35 wt % to 45 wt % copper. These membranes, which also may be referred to as hydrogen-selective membranes, are typically formed from a thin foil that is approximately 0.001 inches thick. It is within the scope of the present invention, however, that the membranes may be formed from hydrogen-selective metals and metal alloys other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations, which are disclosed in the incorporated patents.

Another example of a suitable pressure-separation process for use in separation region 38 is pressure swing absorption (PSA). In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 36. The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent. Impurity gases such as NH₃, H₂S, and H₂O adsorb very strongly on the adsorbent material and are therefore removed from stream 36 along with other impurities. If the adsorbent material is going to be regenerated and these impurities are present in stream 36, separation region 38 preferably includes a suitable device that is adapted to remove these impurities prior to delivery of stream 36 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It should be understood, however, that other suitable adsorbent material compositions, forms and configurations may be used.

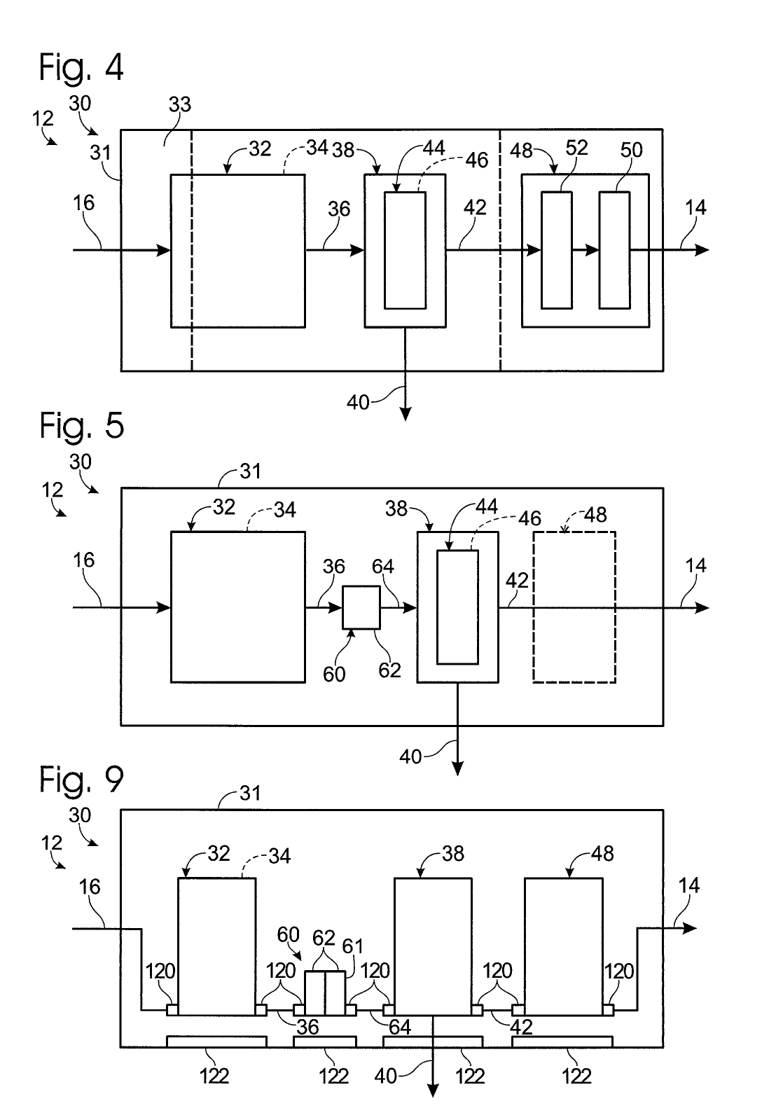

Reformer 30 may, but does not necessarily, further include a polishing region 48, such as shown in FIG. 4. Polishing region 48 receives hydrogen-rich stream 42 from separation region 38 and further purifies the stream by reducing the concentration of, or removing, selected compositions therein. For example, when stream 42 is intended for use in a fuel cell stack, such as stack 22, compositions that may damage the fuel cell stack, such as carbon monoxide and carbon dioxide, may be removed from the hydrogen-rich stream. The concentration of carbon monoxide should be less than 10 ppm (parts per million) to prevent the control system from isolating the fuel cell stack. Preferably, the system limits the concentration of carbon monoxide to less than 5 ppm, and even more preferably, to less than 1 ppm. The concentration of carbon dioxide may be greater than that of carbon monoxide. For example, concentrations of less than 25% carbon dioxide may be acceptable. Preferably, the concentration is less than 10%, even more preferably, less than 1%. Especially preferred concentrations are less than 50 ppm. It should be understood that the acceptable minimum concentrations presented herein are illustrative examples, and that concentrations other than those presented herein may be used and are within the scope of the present invention. For example, particular users or manufacturers may require minimum or maximum concentration levels or ranges that are different than those identified herein.

Region 48 includes any suitable structure for removing or reducing the concentration of the selected compositions in stream 42. For example, when the product stream is intended for use in a PEM fuel cell stack or other device that will be damaged if the stream contains more than determined concentrations of carbon monoxide or carbon dioxide, it may be desirable to include at least one methanation catalyst bed 50. Bed 50 converts carbon monoxide and carbon dioxide into methane and water, both of which will not damage a PEM fuel cell stack. Polishing region 48 may also include another hydrogen-producing device 52, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

Steam reformers typically operate at temperatures in the range of 200° C. and 700° C., and at pressures in the range of 50 psi and 1000 psi, although temperatures outside of this range are within the scope of the invention, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel processing system, or fuel cell system, by an external source, or both.

In FIGS. 3 and 4, reformer 30 is shown including a shell 31 in which the above-described components are contained. Shell 31, which also may be referred to as a housing, enables the fuel processor, such as reformer 30, to be moved as a unit. It also protects the components of the fuel processor from damage by providing a protective enclosure and reduces the heating demand of the fuel processor because the components of the fuel processor may be heated as a unit. Shell 31 may, but does not necessarily, include insulating material 33, such as a solid insulating material, blanket insulating material, or an air-filled cavity. It is within the scope of the invention, however, that the reformer may be formed without a housing or shell. When reformer 30 includes insulating material 33, the insulating material may be internal the shell, external the shell, or both. When the insulating material is external a shell containing the above-described reforming, separation and/or polishing regions, the fuel processor may further include an outer cover or jacket external the insulation.

It is further within the scope of the invention that one or more of the components may either extend beyond the shell or be located external at least shell 31. For example, and as schematically illustrated in FIG. 1, polishing region 48 may be external shell 31 and/or a portion of reforming region 32 may extend beyond the shell. Other examples of fuel processors demonstrating these configurations are illustrated in the incorporated references and discussed in more detail herein.

Although fuel processor 12, feed stream delivery system 17, fuel cell stack 22 and energy-consuming device 25 may all be formed from one or more discrete components, it is also within the scope of the invention that two or more of these devices may be integrated, combined or otherwise assembled within an external housing or body. For example, a fuel processor and feed stream delivery system may be combined to provide a hydrogen-producing device with an onboard, or integrated, feed stream delivery system, such as schematically illustrated at 26 in FIG. 1. Similarly, a fuel cell stack may be added to provide an energy-generating device with an integrated feed stream delivery system, such as schematically illustrated at 27 in FIG. 1.

Fuel cell system 10 may additionally be combined with an energy-consuming device, such as device 25, to provide the device with an integrated, or on-board, energy source. For example, the body of such a device is schematically illustrated in FIG. 1 at 28. Examples of such devices include a motor vehicle, such as a recreational vehicle, automobile, boat or other seacraft, and the like, a dwelling, such as a house, apartment, duplex, apartment complex, office, store or the like, or a self-contained equipment, such as an appliance, light, tool, microwave relay station, transmitting assembly, remote signaling or communication equipment, etc.

It is within the scope of the invention that the above-described fuel processor 12 may be used independent of a fuel cell stack. In such an embodiment, the system may be referred to as a fuel processing system, and it may be used to provide a supply of pure or substantially pure hydrogen to a hydrogen-consuming device, such as a burner for heating, cooking or other applications. Similar to the above discussion about integrating the fuel cell system with an energy-consuming device, the fuel processor and hydrogen-consuming device may be combined, or integrated.

During operation, some particulate may be carried with the fluid streams to the separation region, which contains the hydrogen-separation membrane module. This particulate may be in the form of dust from catalysts upstream from the separation region, such as the (steam or autothermal) reforming catalyst. It may also be from impurities in the feedstock, either as delivered to the fuel processor, or from the recycled byproduct stream which could contain dust from upstream or downstream catalysts (such as reforming or methanation catalysts). Another source of particulate is coke, which may be formed as a byproduct of the reforming reactions.

Regardless of its source, this particulate may interfere with the operation of the hydrogen-selective membrane or membranes used in separation region 38. For example, this particulate may plug the gas flow channels in the membranes. As this occurs, the pressure drop through the membranes increases and eventually requires replacement of the membranes. It should be understood that the time required for the membrane module to need replacing will vary, depending upon such factors as the operating conditions of the fuel processor, the concentration and size of particulate being delivered to the membranes, etc. To prevent this particulate from impairing the operation of membrane module 44, fuel processor 12 may include a filter assembly 60 intermediate its reforming region and the separation region, such as shown in FIG. 5. In FIG. 5, polishing region 48 is shown in dashed lines to schematically illustrate that the filter assembly may be used with any of the fuel processors described and/or illustrated herein or in the incorporated references.

Filter assembly 60 is adapted to remove or reduce the amount of particulate in reformate stream 36 prior to delivery of the stream to the fuel processor's separation region 38. As such, filter assembly 60 may also be described as a particle-gas separator. As shown, filter assembly 60 receives reformate stream 36 and a filtered stream 64 is delivered to separation region 38 from the filter assembly. Filter assembly 60 includes at least one filter element 62. Filter element 62 includes any suitable device adapted to remove particulates from reformate stream 36 at the elevated temperatures at which the fuel processor operates. An example of a suitable filter element is a porous medium through which the reformate stream may flow, and in which particulates contained in the reformate stream are retained.

An example of a suitable form for filter element 62 is a sintered metal tube or disc. Another example is a woven metal mesh, such as filter cloth that is fabricated into the shape of a tube or disc. Ceramic tubes and discs are also suitable filter elements. A 2-micron filter that operates at temperatures in the range of 700° C. has proven effective as a filter element, however, it should be understood that the size (namely, the size of the smallest particulate that will be trapped by the filter) and the composition of the filter may vary. Another suitable filter element is a device in which the reformate stream passes through an elbow or other conduit containing a trap, which retains the particulate. Filter assembly 60 may also include two or more filter elements 62, such as filter elements that may have the same or different sizing and/or different types of filter elements. Particulate that may be present in the hot reformate gas as it exits the reforming region are retained on the filter element.

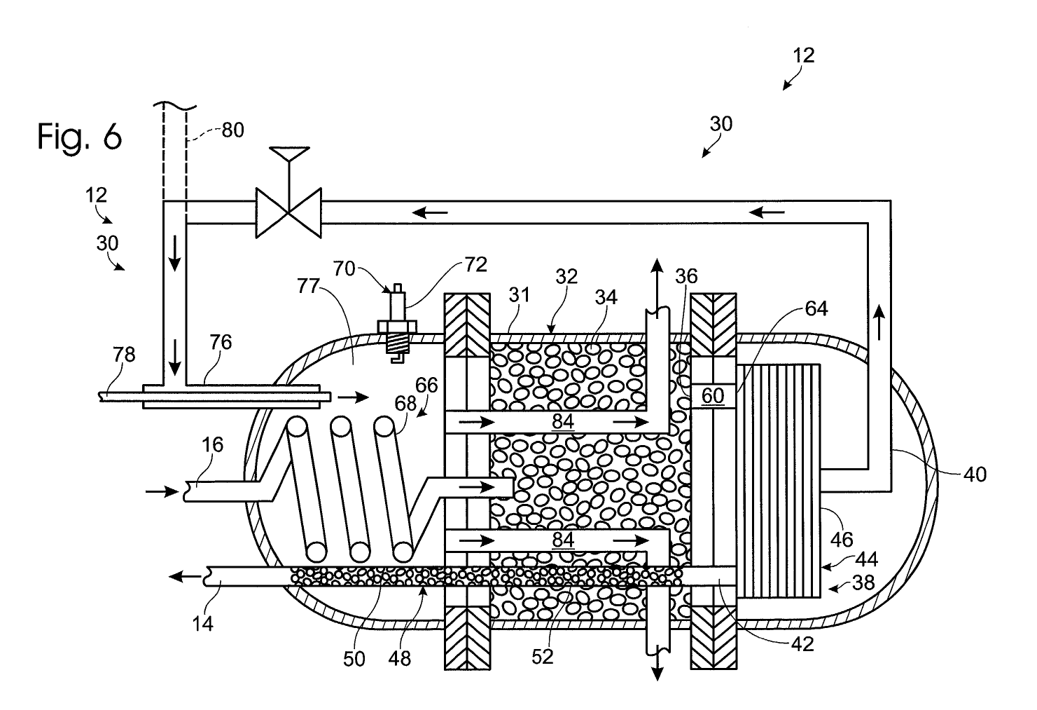

FIG. 6 provides an illustrative example of a steam reformer 30 containing a filter assembly 60 intermediate its reforming and separation regions. As shown, reformate stream 36 passes through filter assembly 60. The stream leaves filter assembly 60 as filtered stream 64 and is delivered to separation region 38, which in the illustrated example takes the form of a membrane module 44 containing a plurality of hydrogen-selective metal membranes 46.

Also shown in FIG. 6 is an example of a steam reformer that contains a vaporization region 66, in which feed stream 16 is vaporized prior to delivery to reforming region 32. Vaporization region 66 includes a vaporization coil 68, which is contained within the shell 31 of the reformer. It is within the scope of the invention that the vaporization region (and coil) may be located external the shell of the fuel processor, such as extending around the shell or otherwise located outside of the shell. The feed stream in vaporization region 66 is vaporized by heat provided by a heating assembly 70 that includes a heating element 72, which in the illustrated embodiment takes the form of a spark plug. Examples of other suitable heating elements include glow plugs, pilot lights, combustion catalysts, resistance heaters, and combinations thereof, such as a glow plug in combination with a combustion catalyst.

Heating assembly 70 consumes a fuel stream 76, which may be a combustible fuel stream or an electric current, depending upon the type of heating element used in the heating assembly. In the illustrated embodiment, the heating assembly forms part of a combustion chamber, or region, 77, and the fuel stream includes a combustible fuel and air from an air stream 78. The fuel may come from an external source, such as schematically illustrated at 80, or may be at least partially formed from the byproduct stream 40 from separation region 38. It is within the scope of the invention that at least a portion of the fuel stream may also be formed from product hydrogen stream 14. In the illustrated embodiment, the exhaust from combustion region 77 flows through heating conduits 84 in reforming region 32 to provide additional heating to the reforming region. Conduits 84 may take a variety of forms, including finned tubes and spirals, to provide sufficient surface area and desirable uniform distribution of heat throughout reforming region 32.

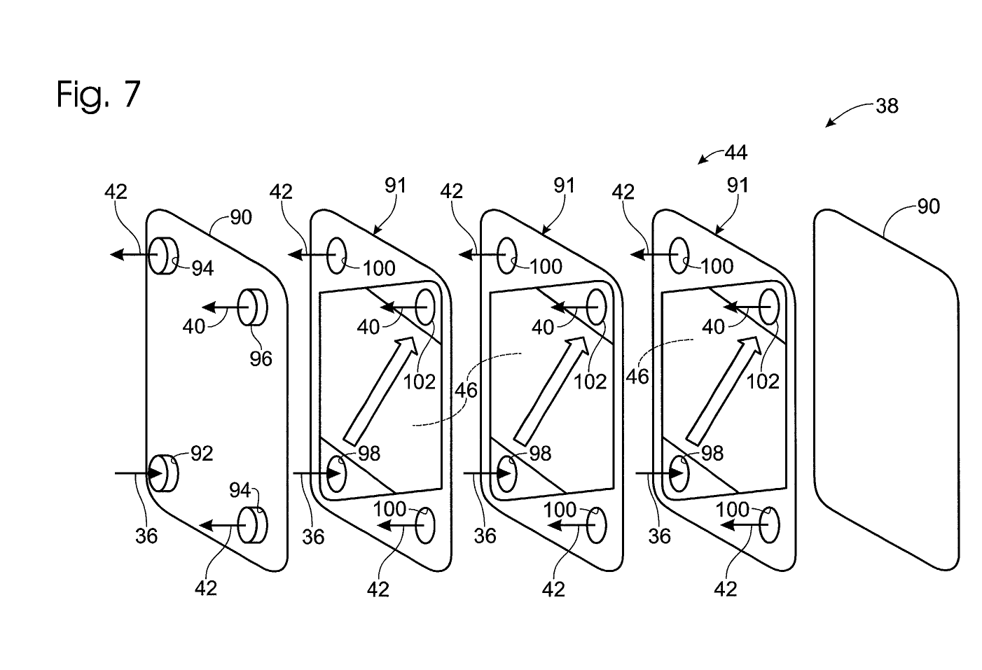

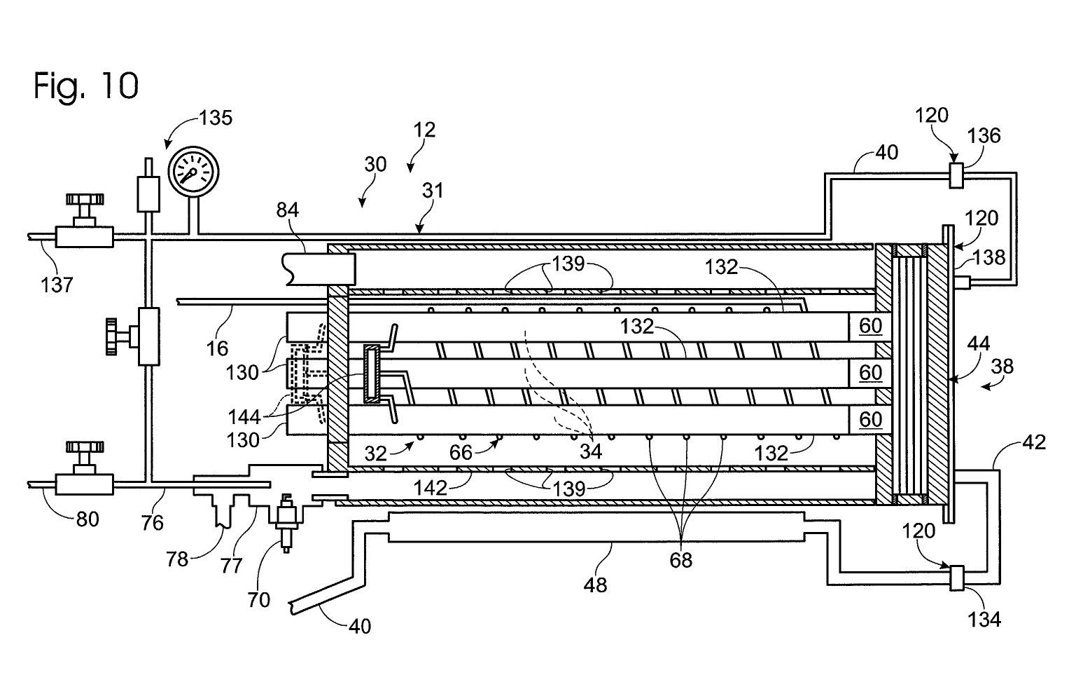

As discussed, separation region 38 may include a membrane module 44 that contains one or more hydrogen-selective metal membranes 46, which may also be referred to as hydrogen-permeable metal membranes. An example of a suitable membrane module is shown in FIG. 7 in the form of a plate membrane module. As shown, the module contains end plates 90 between which one or more membrane envelopes 91 are contained. In the illustrated embodiment, three membrane envelopes are shown for purposes of illustration, but it should be understood that more or less envelopes may be used. The membrane envelopes are in fluid communication with at least one of the end plates, through which the reformate gases (in reformate stream 36 or filtered stream 64) are delivered and from which the byproduct 40 and hydrogen-rich 42 streams are removed. As shown, one of the end plates contains a reformate input port 92 for reformate stream 36 or filtered stream 64, a pair of exit ports 94 for hydrogen-rich stream 42 and an exit port 96 for byproduct stream 40. It should be understood that the number and sizing of the ports for each stream may vary, and that at least one of the ports may be contained on the other end plate or elsewhere on the membrane module, such as on a housing 97 between the end plates, which is shown in FIG. 10. As shown, the membrane envelopes include conduits 98, 100 and 102 that establish fluid communication with the input and exit ports and between the membrane envelopes. When membrane envelopes 91 are stacked, these various ports align and provide fluid conduits.

In operation, reformate gas is introduced to the membrane module through port 92 and is delivered to the membrane envelopes. Hydrogen gas that passes through the hydrogen-selective membranes 46 flows to conduits 100 and is removed from the membrane module through ports 94. The rest of the reformate gases, namely the portion that does not pass through the hydrogen-selective membranes, flows to conduit 102 and is removed from the membrane module as byproduct stream 40 through port 96.

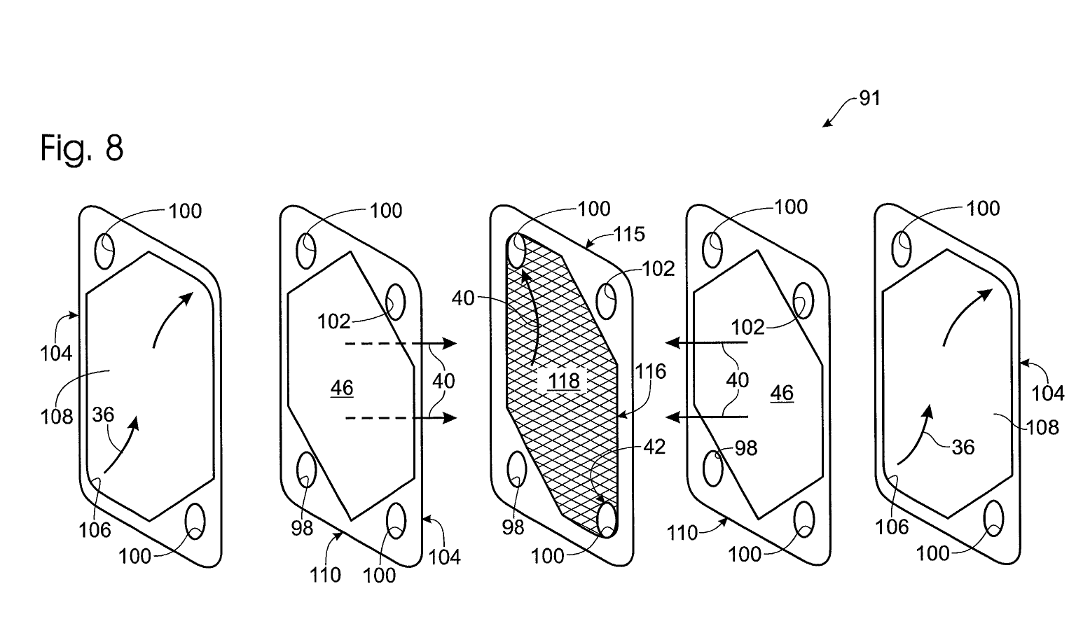

Each of the membrane envelopes 91 includes at least one hydrogen-selective membrane 46. FIG. 8 illustrates in exploded view an example of a suitable construction for membrane envelope 91, which as shown contains a plurality of stacked plate elements. In FIG. 8, each of the plate elements includes ports establishing communication through the membrane envelope, as described above in connection with FIG. 7. Some of these ports, however, are “open” laterally into the corresponding plate element and thereby provide lateral access to portions of module 44.

Each membrane envelope 91 includes spacer plates 104 as the outer most plates in the stack. Generally, each of spacer plates includes a frame 106 that defines an inner open region 108. Each inner open region 108 couples laterally to conduits 98 and 102. Conduits 100, however, are closed relative to open region 108, thereby isolating the hydrogen-rich stream 42.

Each membrane envelope 91 also includes membrane plates 110 adjacent and interior to plates 104. Membrane plates 110 each include as a central portion thereof a hydrogen-selective membrane 46, such as a palladium alloy membrane, which may be secured to an outer frame 114 that is shown for purposes of illustration. In plates 110, all of the ports are closed relative to membrane 46. Each membrane lies adjacent to a corresponding one of open regions 108, i.e., adjacent to the hydrogen-rich reformate flow arriving by way of port 92. This provides opportunity for hydrogen to pass through the membrane, with the remaining gases, i.e., the gases forming byproduct stream 40, leaving open region 108 through conduit 102.

A screen plate 115 lies intermediate membrane plates 110, i.e., on the interior or permeate side of each of membranes 46. Screen plate 115 includes a screen assembly 116. Conduits 98 and 102 are closed relative to the central region of screen plate 115, thereby isolating the byproduct stream 40 and the reformate-rich flow 36 (or 64) from hydrogen-rich stream 42. Conduits 100 are open to the interior region of screen plate 115. Hydrogen, having passed through the adjoining membranes 46, travels along and through screen assembly 116 to conduits 100 and eventually to port 94 as the hydrogen-rich stream 42.

The screen assembly may include one or more screen elements 118, and in some embodiments may include outer fine mesh screens and an inner coarse mesh screen. Screen assembly 116 not only provides a flow path for the flow of hydrogen-rich stream 42, but also bears the pressure differential applied to membranes 46 to force hydrogen gas across the membranes. To the extent that membranes 46 are supported without damage by an appropriate structure, e.g., screen assembly 116, thinner and less expensive membranes may be employed. Alternative materials to screen elements 118 include porous ceramics, porous carbon, porous metal, ceramic foam, carbon foam, and metal foam.

A variety of methods, including brazing, gasketing, and welding, may be used, individually or in combination, to achieve gas-tight seals between plates forming membrane envelope 91, as well as between the membrane envelopes. It should be understood that the generally rectangular plate membrane envelopes shown in FIGS. 7 and 8 have been shown for purpose of illustration, and that the membrane envelope may take any suitable shape, such as a circular shape, and may take any suitable form, such as tubular form. Other suitable membrane module and envelope configurations are shown in the incorporated references.

As discussed, fuel processor 12, which may, but does not necessarily, take the form of a steam reformer 30, may be housed in a shell 31. As further discussed, a shell provides greater heating efficiency of the components of the fuel processor or reformer, as well as enabling these components to be more readily transported as a unit and protecting these components from damage caused by physical forces applied to the fuel processor or reformer. A disadvantage of housing the components of fuel processor 12 or reformer 30 in a shell is that it is more difficult to access the individual components of the fuel processor, such as for inspection, maintenance, removal or repair. Typically, the fuel processor or reformer needs to be shut down, cooled, opened through the removal of at least a portion of the shell, sufficiently disassembled to access and remove or repair the particular component, and then reassembled.

A fuel processor and steam reformer that offers the benefits of a shell without the disadvantages discussed above is shown in FIG. 9 and may be referred to as a cartridge-based, or modular, fuel processor, or if the fuel processor produces hydrogen gas by steam or autothermal reforming, a cartridge-based or modular reformer. For purposes of illustration, a cartridge-based reformer will be described in the following discussion, but it should be understood that it is within the scope of the invention that the cartridge-based fuel processor may take other forms than steam or autothermal reforming.

As shown in FIG. 9, the former includes the previously discussed reforming, separation and polishing regions 32, 38, 48, as well as filter assembly 60. It should be understood that the reformer may be implemented without including all of these components, such as described above and in the incorporated references. Reformer 30 further includes a shell 31 that contains access ports 122 through which one or more components may be accessed and/or removed. Ports 122 may take any suitable form, such as a removable panel, end plate, hatch, cover or similar structure. As shown, reforming region 32, filter assembly 60, separation region 38 and polishing region 48 are formed as discrete components, which may also be described as being cartridge-based, modular, or compartmentalized components. In some embodiments, the components may also be described as being self-contained or cartridges.

The modular component may, but is not necessarily in all embodiments, be described as being adapted to receive a fluid-containing stream, and in those embodiments may, but is not necessarily in all embodiments, be described as outputting a gas-containing stream having a different composition that the fluid-containing stream received by the modular component. Typically, the fluid-containing stream will be a gas-containing stream, such as the reformate stream, mixed gas stream, hydrogen-rich stream, product hydrogen stream, filtered stream, byproduct stream, or other streams described or illustrated herein. Similar to the above discussion with respect to feed stream 16, it should be understood that this description of a modular component is meant to include, but not require, more than one fluid- or gas-containing stream being received and/or outputted by the modular component.

In the illustrated embodiment, the components include fittings 120 that are positioned for access from external shell 31, such as through access ports 122. Fittings 120 may take any suitable construction that enables the cartridge-based components to be removed in whole or in part. An example of a suitable fitting 120 is a coupling in a fluid communication line to and/or from a particular component. By disconnecting the fitting, the component may be removed in its entirety. Another example of a fitting is a seal, mounting bracket, receptacle or other releasable retainer that receives a replaceable cartridge, such as a cartridge containing a filter element, reforming catalyst, or other portion of the fuel processor or reformer that may need to be periodically replaced or recharged.

To illustrate the use of cartridge-based, or discrete, components, consider filter assembly 60. Filter assembly 60 may include a housing 61 that receives one or more filter elements 62 in the form of a cartridge. In the illustrated embodiment, two filter elements are shown, but it is within the scope of the invention that this number may vary from a single filter element, to multiple filter elements within the same cartridge, to multiple filter elements each forming a separate cartridge. Via access port 122, the filter element may be removed from filter housing 61, such as to replace the filter with a fresh filter. Alternatively or additionally, the entire filter assembly, including housing 61, may be removed as a unit by disconnecting fittings 120. Similarly, other components of the fuel processor, or steam reformer, may include similar cartridge-based components and sub-components.

It is also within the scope of the invention that the cartridge-based components may be located at least partially or completely outside of the shell or otherwise accessible from external the shell, in which case an access port is not needed. It should be understood that the terms “cartridge,” “cartridge-based,” “modular,” “discrete” and “compartmentalized” are meant to refer to components of a fuel processor that may be readily removed as a unit from the fuel processor without requiring the level of disassembly traditionally required. The use of cartridge-based components enables a component that requires servicing or repair to be quickly removed and replaced, even by individuals, such as consumers, that are not trained in the operation and maintenance of the fuel processor. A replacement cartridge may be inserted in place of the removed cartridge, with only minor effort required and only minor, if any, downtime. The removed cartridge may then be discarded, serviced or otherwise repaired. Similarly, the use of replaceable cartridges enables outdated components to be replaced or augmented, such as when improved modules become available or as operational requirements or parameters change. When access ports are used, the fittings should be located in a position for ready access and disconnection of the component or subcomponent, and in some embodiments should enable the component or subcomponent to be accessed and/or removed and replaced without shutting down the fuel processor.

An example of a steam reformer 30 containing at least one cartridge-based component is shown in FIG. 10. FIG. 10 also provides another illustrative example of a fuel processor in which a component is completely external the fuel processor's shell, namely, polishing region 48, and an example of a fuel processor in which a portion of a component extends beyond the shell, such as portions 130 of reforming tubes 132. As shown, polishing region 48 is coupled to the rest of fuel processor 12 via fitting 134. Upon disconnection of fitting 134, which in the illustrated embodiment may be accessed from external the fuel processor's shell, the polishing region may be removed as a unit, such as for inspection, maintenance, repair and/or replacement. Similarly, separation region 38, namely, membrane module 44, may be removed as a unit upon disconnection of fittings 134 and 136 and removal of access port 122, which in the illustrated embodiment takes the form of a cover plate 138. It is within the scope of the present invention that the membrane module or other embodiment of separation region 38 may be coupled to the rest of the fuel processor without using a cover plate. For example, the module may be threadingly connected to shell 31 (with mating sets of threads on the shell and the module's housing or one of the module's end plates). As another example, a friction fit may be used, and/or other releasable fasteners, such as a strap, clips, clasps, pins or the like. Similarly, cover plate 138 may be coupled to shell 31 using any of these mechanisms.

The steam reformer shown in FIG. 10 also provides an illustrative example of a fuel processor that includes a vaporization region 66 within the shell of the fuel processor, a steam reformer that includes multiple reforming tubes 132, a fuel processor that includes a filter assembly 60, and a fuel processor in which the byproduct stream may be either used as a portion of fuel stream 76 for combustion region 77, vented (such as through pressure-relief valve assembly 135), or delivered through fluid conduit 137 for storage or use outside of fuel processor 12. Also shown in FIG. 10 are flow regulators 139 for heat produced by heating assembly 70 in combustion region 77. In the illustrated embodiment, regulators 139 take the form of apertures in combustion manifold 142. The apertures regulate the path along which combustion exhaust travels from combustion region 77 and through reforming region 32. Examples of suitable placement of the apertures include one or more apertures distal heating assembly 70, and a plurality of apertures distributed along the length of manifold 142, such as shown in FIG. 10. When a distribution of spaced-apart apertures is used, the apertures may be evenly spaced, or the openings may be more prevalent distal the burner. Similarly, the size of the apertures may be uniform, or may vary, such as using larger apertures away from heating assembly 70.

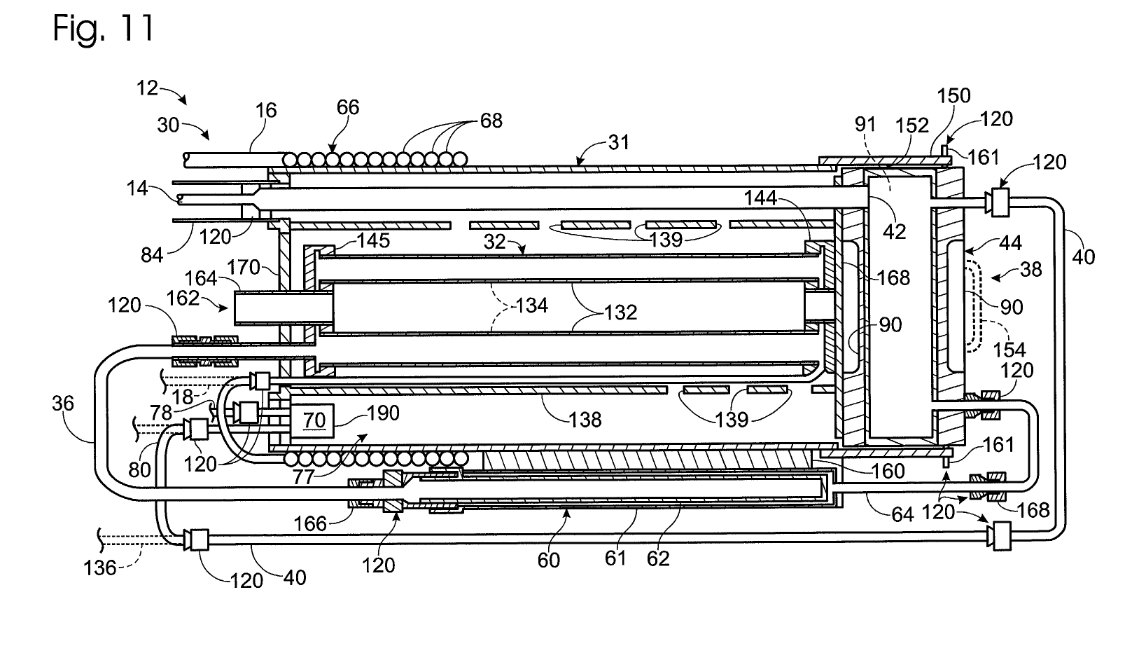

In the illustrated embodiment, the vaporized feed stream 16 from vaporization coil 68 is delivered to a manifold 144 that distributes the feed stream between reforming catalyst tubes 132. As shown in dashed lines in FIG. 10, the manifold may alternatively be located external shell 31 to enable access to the manifold from external the shell, such as to adjust the relative distribution of the vaporized feed stream between the reforming catalyst tubes. For example, if a particular tube needs to be removed, repaired, or otherwise taken out of service, the manifold may be manipulated so that feed stream 16 is not delivered to that particular tube. This enables the reformer to be used without requiring shut down of the reformer, and in some embodiments, enables removal, replacement and/or repair of the tube and/or the reforming catalyst 34 contained within while the reformer is in operation. Also shown in FIG. 11 is a reformate manifold 145 in which the reformate gas stream from the reforming tubes is collected prior to delivery to filter assembly 60, or separation region 38 if the reformer does not include a filter assembly.

Another embodiment of a cartridge-based reformer is shown in FIG. 11. Unless otherwise specified, the reformer shown in FIG. 11, as well as the other reformers and fuel processors included herein, may have any of the features, elements, subelements, and variations elsewhere discussed herein. In the illustrated embodiment, the reformer includes a shell 31 having a region 150 that defines a receptacle 152 into which separation region 38, namely membrane module 44, is at least partially received. As shown, the membrane module is partially received within the receptacle and extends partially beyond the shell, but it is within the scope of the invention that the separation region may extend completely within the receptacle. Also shown in dashed lines is a handle 154 that may be used to facilitate removal of the membrane module from the shell, such as from within receptacle 152. Handle 154 may take any suitable form that is adapted to be grasped by a user to draw the membrane module from the shell, such as finger holes, the projecting handle shown in FIG. 11, etc. Upon removal of membrane module 44, reforming region 32 may be removed through receptacle 152, such as by grasping a support 168 to which the reforming region is mounted. Alternatively, support 168 may be omitted, and the reforming region may be directly grasped and removed from the reformer, such as by grasping manifold 144 or an associated region that is adapted to be grasped by a user. As a further alternative, the reforming region may be removed from the reformer by withdrawing the region from the other end of the shell, either along with cover plate 170 or after removal of the cover plate. As a further alternative, the reforming region may be removed though an access port in the shell generally between these two regions. It should be understood that various fittings 120 will need to be disconnected to remove the reforming region.

The reformer of FIG. 11 provides another example of a fuel processor in which a component of the fuel processor is located external the shell. In the illustrated embodiment, filter assembly 60 is shown external shell 31. Filter assembly 60 may also be described as a modular or cartridge-based component because it may be removed from the reformer through the disconnection of one or both of fittings 166 and 168. Also shown in FIG. 11 is a heat transfer member 160 that heats the filter assembly by conducting heat from the shell of the fuel processor. Any suitable heat conductive material may be used for member 160, with stainless steel proving effective in testing. The reformer of FIG. 11 also illustrates another mechanism for coupling membrane module 44 to shell 31, namely through the use of a fitting 120 in the form of releasable clips or pins 161.

The reformer of FIG. 11 also includes an air delivery system 162 that includes a delivery conduit 164 adapted to deliver an air stream to cool reforming region 32. Air delivery system 162 may utilize any suitable mechanism, such as a fan, blower, etc. It should be noted that the delivery conduit does not introduce air directly into the reforming catalyst tubes 132, but instead delivers a stream of air into the combustion region or other portion of the reformer extending around the reforming tubes. As shown, the delivery conduit extends generally parallel to the reforming tubes, but it should be understood that other orientations and delivery positions may be used and are within the scope of the invention. By regulating the flow and/or temperature of air delivered by system 162, the temperature of the reforming region may be controlled, such as responsive to one or more temperature sensors positioned to measure the temperature on, within or near the reforming tubes, or elsewhere within the reformer or other fuel processor.

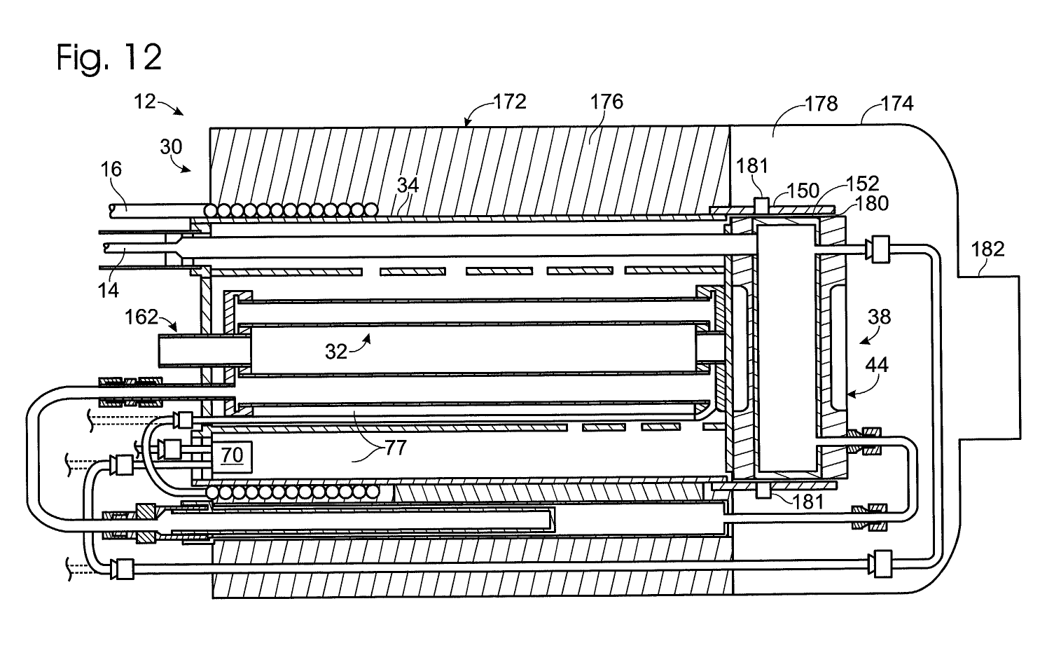

As discussed, fuel processor 12 may be jacketed with an insulating material. An example of such a fuel processor is shown in FIG. 12 in the form of a reformer 30. As shown, reformer 30 includes an exterior housing or cover 172 surrounding shell 31. In the illustrated embodiment, cover 172 includes a removable hood 174 that extends around membrane module 44. To illustrate various types of insulation that may be used, a portion of the space between shell 31 and cover 172 is shown containing solid insulation 176, and another portion, namely the portion within hood 174 is shown containing air.

Also shown in FIG. 12, is a passage 180 through which some of the exhaust from combustion region 77 may pass to provide heat to separation region 38. The reformer may, but does not necessarily, include a duct assembly 181 to enable the relative flow through passage 180 to be controlled. It should be understood that duct assembly 181 has been schematically illustrated in FIG. 12 and that it may take any suitable form to selectively control the relative flow of exhaust through passage 180, and thereby may be located anywhere along or adjacent the ends of the passage. After leaving passage 180, the exhaust leaves cover 172 through an exhaust port 182 formed in the hood.

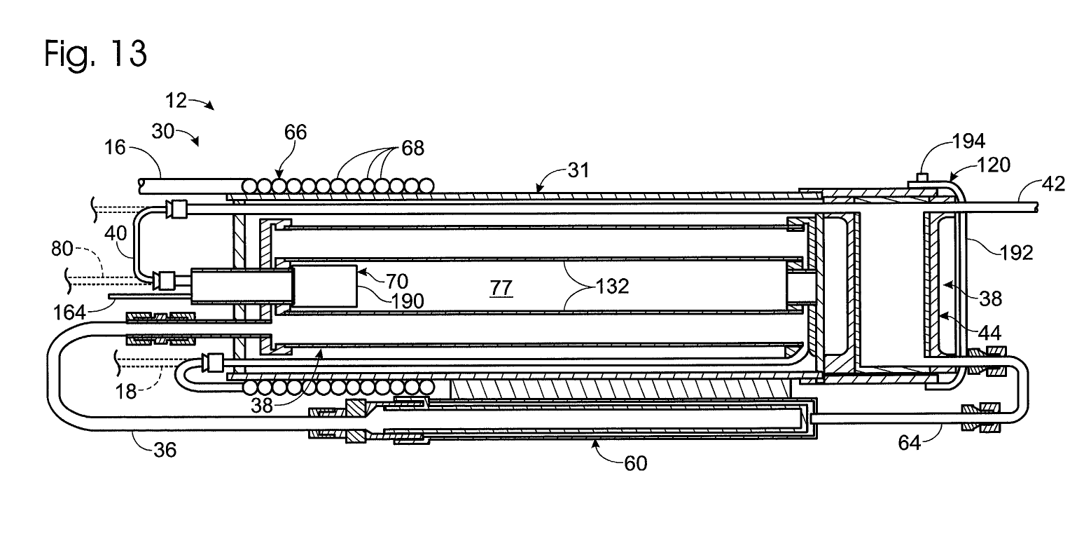

In FIG. 13 another embodiment of a suitable reformer 30 is shown. The reformer of FIG. 13 is similar to the reformer shown in FIG. 11, except that the heating assembly 70 has been centralized to more directly heat the portion of the reformer containing reforming tubes 132. As shown, the heating assembly is shown generally where the air delivery conduit was previously illustrated in FIG. 11. As discussed, heating assembly 70 may take many different forms, one of which is a burner 190, which his shown for purposes of illustration. In the illustrated embodiment, burner 190 receives a combustible fuel from at least one of an external supply 80 and byproduct stream 40. Burner 190 also receives air from conduit 164 from the air delivery system. It should be understood that the same or a different air delivery system may also provide an air stream for controlling the temperature of the reforming region, such as discussed above with respect to FIG. 11. By comparing FIGS. 11 and 13, it can be seen that centralizing the heating assembly enables, but does not require, that the relative size of the fuel processor may be reduced.

In the embodiment illustrated in FIG. 13, a polishing region 48 is not illustrated. It should be understood that the reformer may be formed without a polishing region, that the polishing region may be located external shell 31, such as shown in FIG. 10, or that the polishing region may extend within the shell. For example, the polishing region may extend within the shell generally parallel to the reforming tubes. The reformer of FIG. 13 also illustrates another suitable mechanism for coupling the membrane module or other separation region to shell 31, namely through the use of a fitting 120 in the form of a strap 192. As shown, strap 192 extends from shell 31 on one side of membrane module 44 and releasably engages a retainer 194 on the other side of shell 31. Alternatively, one or more straps may extend from the membrane module and be engaged by the shell or other portion of the fuel processor.

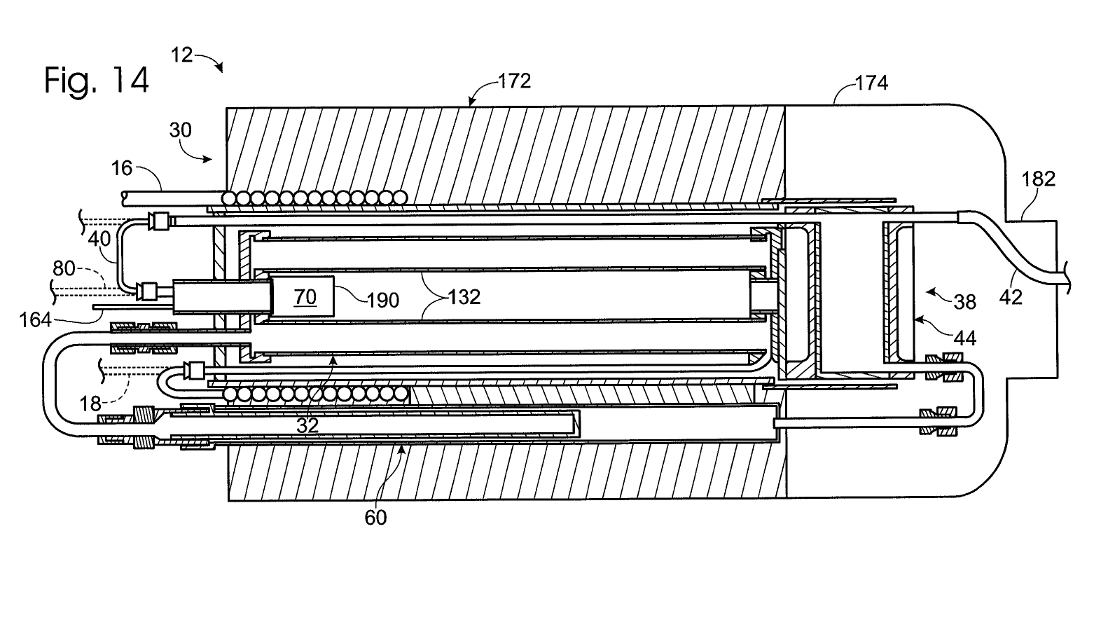

Similar to the embodiment of the reformer shown in FIG. 11, the reformer shown in FIG. 13 may also include an external cover or housing, such as shown in FIG. 14.

It should be understood that the features described and illustrated herein may be used together or separately. For example, a fuel processor according to the present invention may be implemented with one or more cartridge-based components, with an air delivery system to control the operating temperature of the fuel processor, with a filter assembly, etc., either alone or in combination with these or other features and elements described herein.

### Industrial Applicability

The present invention is applicable in any fuel processing system or fuel cell system in which hydrogen gas is produced for delivery to a fuel cell stack or other hydrogen-consuming device.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A fuel processor, comprising:
a shell including at least one input adapted to receive a feed stream containing a feedstock and at least one output adapted to emit a product hydrogen stream containing at least substantially pure hydrogen gas;
a hydrogen-producing region at least partially contained within the shell and adapted to receive the feed stream and to produce a mixed gas stream containing hydrogen gas and other gases therefrom; and
a separation region adapted to receive the mixed gas stream and to separate the mixed gas stream into a hydrogen-rich stream forming at least a substantial portion of the product hydrogen stream and containing at least substantially hydrogen gas and a byproduct stream containing at least substantially the other gases;
wherein at least a portion of the fuel processor is a modular component that is adapted to be accessed, removed from and replaced as a unit into an operational position of the fuel processor.

2. The fuel processor of claim 1, wherein the modular component is adapted to receive a gas-containing stream having a composition and to outlet a gas-containing stream having a different composition.

3. The fuel processor of claim 1, wherein one of at least a portion of the separation region or a portion of the hydrogen-producing region forms the modular component and is adapted to be independently removable from the other of at least a portion of the separation region or a portion of the hydrogen-producing region.

4. The fuel processor of claim 1, wherein the modular component is operatively coupled to the fuel processor by at least one releasable fitting.

5. The fuel processor of claim 4, wherein the at least one releasable fitting establishes fluid communication between the modular component and another portion of the fuel processor.

6. The fuel processor of claim 4, wherein the at least one releasable fitting is adapted to selectively retain the modular component in an operative position forming a portion of the fuel processor.

7. The fuel processor of claim 1, wherein the shell includes at least one access port through which the modular component may be accessed, removed and reattached through the shell.

8. The fuel processor of claim 7, wherein the modular component is operatively coupled to the fuel processor by at least one releasable fitting and further wherein the at least one releasable fitting is positioned for access, release and reattachment by a user through the access port.

9. The fuel processor of claim 1, wherein the fuel processor includes a plurality of modular components, each adapted to be accessed, removed from and replaced into an operative position as a portion of the fuel processor.

10. The fuel processor of claim 9, wherein the shell includes a plurality of access ports, each adapted to selectively permit access to, removal and replacement of at least one modular component from the fuel processor.

11. The fuel processor of claim 1, wherein the hydrogen-producing region is completely contained within the shell.

12. The fuel processor of claim 1, wherein the hydrogen-producing region includes a reforming region containing at least one reforming catalyst bed.

13. The fuel processor of claim 12, wherein the modular component includes the reforming region.

14. The fuel processor of claim 12, wherein at least a portion of the reforming region forms at least a substantial portion of the modular component.

15. The fuel processor of claim 12, wherein the modular component includes a reforming catalyst bed that is adapted to be removed and replaced as a unit from the fuel processor relative to the rest of the reforming region.

16. The fuel processor of claim 15, wherein the reforming region includes a plurality of reforming catalyst beds, each forming a separate modular component that is adapted to be removed and replaced as a unit from the fuel processor relative to the rest of the reforming region.

17. The fuel processor of claim 1, wherein the separation region is at least partially contained within the shell.

18. The fuel processor of claim 1, wherein the separation region is completely contained within the shell.

19. The fuel processor of claim 1, wherein the separation region is adapted to separate the mixed gas stream into the hydrogen-rich stream and the byproduct stream via a pressure-driven separation process.

20. The fuel processor of claim 1, wherein the separation region includes at least one hydrogen-selective membrane.

21. The fuel processor of claim 20, wherein the modular component includes the at least one hydrogen-selective membrane.

22. The fuel processor of claim 1, wherein the separation region includes a membrane module containing a plurality of hydrogen-selective membranes.

23. The fuel processor of claim 22, wherein the membrane module further includes a pair of end plates between which the hydrogen-selective membranes are mounted.

24. The fuel processor of claim 23, wherein the membrane module includes at least one output port through which the byproduct stream is removed from the membrane module, and at least one output port through which the hydrogen-rich stream is removed from the membrane module.

25. The fuel processor of claim 22, wherein the modular component includes the membrane module and is adapted to be accessed, removed from and replaced into an operative position relative to the fuel processor.

26. The fuel processor of claim 22, wherein at least a portion of the membrane module forms at least a substantial portion of the modular component.

27. The fuel processor of claim 1, wherein the fuel processor further includes a filter assembly adapted to remove particulate from the mixed gas stream.

28. The fuel processor of claim 27, wherein the modular component includes the filter assembly.

29. The fuel processor of claim 27, wherein at least a portion of the filter assembly forms at least a substantial portion of the modular component.

30. The fuel processor of claim 27, wherein the filter assembly includes at least one filter element.

31. The fuel processor of claim 30, wherein at least one of the at least one filter elements forms the modular component.

32. The fuel processor of claim 27, wherein the filter assembly is located at least partially within the shell.

33. The fuel processor of claim 27, wherein the filter assembly is located external the shell.

34. The fuel processor of claim 27, wherein the modular component includes the separation region and the filter assembly.

35. The fuel processor of claim 1, wherein the fuel processor further includes a purification region adapted to receive the hydrogen-rich stream and to reduce the concentration of selected components of the hydrogen-rich stream to form a product hydrogen stream.

36. The fuel processor of claim 35, wherein the modular component includes the purification region.

37. The fuel processor of claim 35, wherein at least a portion of the purification region forms at least a substantial portion of the modular component.

38. The fuel processor of claim 35, wherein the purification region includes a methanation catalyst bed.

39. The fuel processor of claim 38, wherein the modular component includes the methanation catalyst bed.

40. The fuel processor of claim 38, wherein the purification region further includes a reforming catalyst bed.

41. The fuel processor of claim 40, wherein the reforming catalyst bed is upstream from the methanation catalyst bed.

42. The fuel processor of claim 40, wherein the modular component includes the reforming catalyst bed.

43. The fuel processor of claim 1, wherein the fuel processor includes an air delivery system adapted to deliver an air stream to the fuel processor.

44. The fuel processor of claim 43, wherein the fuel processor includes a combustion chamber with a heating assembly and the air delivery system is adapted to deliver the air stream to the heating assembly.

45. The fuel processor of claim 43, wherein the fuel processor includes a combustion chamber and the air delivery system is adapted to selectively deliver the air stream to the combustion chamber to regulate the temperature of the combustion chamber.

46. The fuel processor of claim 1, in combination with at least one hydrogen-consuming device adapted to receive at least a portion of the product hydrogen stream from the fuel processor.

47. The fuel processor of claim 46, further including a housing in which the fuel processor and the at least one hydrogen-consuming device are contained.

48. The fuel processor of claim 46, wherein the fuel processor and the at least one hydrogen-consuming device are integrated together.

49. The fuel processor of claim 46, wherein the at least one hydrogen-consuming device includes a motor vehicle.

50. The fuel processor of claim 46, wherein the at least one hydrogen-consuming device includes a household appliance.

51. The fuel processor of claim 1, in combination with a fuel cell stack adapted to receive at least a portion of the product hydrogen stream from the fuel processor and to produce an electric current therefrom.

52. The fuel processor of claim 51, further including a housing in which the fuel processor and the fuel cell stack are contained.

53. The fuel processor of claim 51, wherein the fuel processor and the fuel cell stack are integrated together to provide an energy-producing device with an integrated hydrogen-producing system.

54. The fuel processor of claim 51, in further combination with at least one energy-consuming device adapted to draw the electric current from the fuel cell stack.

55. The fuel processor of claim 54, further including a housing adapted to receive the fuel processor, fuel cell stack and the at least one energy-consuming device.

56. The fuel processor of claim 54, wherein the fuel processor, fuel cell stack and the at least one energy-consuming device are integrated together to provide an energy-consuming device with an integrated energy-producing system.

57. The fuel processor of claim 54, wherein the at least one energy-consuming device includes a heater.

58. The fuel processor of claim 54, wherein the at least one energy-consuming device includes a motor vehicle.

59. The fuel processor of claim 54, wherein the at least one energy-consuming device includes an appliance.

60. The fuel processor of claim 54, wherein the at least one energy-consuming device includes a lighting assembly.

61. The fuel processor of claim 54, wherein the at least one energy-consuming device includes communications equipment.

62. The fuel processor of claim 54, wherein the at least one energy-consuming device includes signaling equipment.

63. The fuel processor of claim 54, wherein the at least one energy-consuming device includes a seacraft.

64. The fuel processor of claim 54, wherein the at least one energy-consuming device includes a dwelling.

65. An integrated hydrogen-consuming device and hydrogen producing assembly, the device comprising:
a fuel processor adapted to produce a product hydrogen stream containing at least substantially pure hydrogen gas from a feed stream and including at least one modular component that is adapted to be removed and replaced as a unit from the fuel processor; and
a hydrogen-consuming device adapted to receive at least a portion of the product hydrogen stream.

66. An integrated power-consuming device and energy producing assembly, the device comprising:
a fuel processor adapted to produce a product hydrogen stream containing at least substantially pure hydrogen gas from a feed stream and including at least one modular component that is adapted to be removed and replaced as a unit from the fuel processor; and
a fuel cell stack adapted to receive at least a portion of the product hydrogen stream from the fuel processor and to produce an electric current therefrom; and
a power-consuming device adapted to draw at least a portion of the electric current from the fuel cell stack.

67. In a fuel processor adapted to produce hydrogen gas from a feed stream, the improvement comprising at least one cartridge-based component forming an operative portion of the fuel processor and being adapted to be accessed, removed from and placed as a unit into an operative position as a portion of the fuel processor.

68. The fuel processor of claim 67, wherein each of the at least one cartridge-based components is removably coupled in the operative position by at least one releasable fitting.

69. The fuel processor of claim 67, wherein the fuel processor includes a shell containing an access port through which at least one of the at least one cartridge-based components may be accessed, removed from and replaced as a unit into the operative position within the fuel processor.

70. The fuel processor of claim 67, wherein the at least one cartridge-based component includes a hydrogen-producing region adapted to receive the feed stream and produce a stream containing hydrogen gas therefrom.

71. The fuel processor of claim 67, wherein the at least one cartridge-based component includes a separation region adapted to receive a mixed gas stream containing hydrogen gas and other gases and to separate the mixed gas stream into a hydrogen-rich stream containing at least substantially hydrogen gas and a byproduct stream containing at least substantially the other gases.

72. The fuel processor of claim 67, wherein the at least one cartridge-based component includes a filter assembly adapted to remove particulate from a stream delivered thereto.

73. The fuel processor of claim 67, wherein the at least one cartridge-based component includes a filter element adapted to remove particulate from a stream delivered thereto.

74. The fuel processor of claim 67, wherein the at least one cartridge-based component includes a reforming region containing a reforming catalyst and adapted to receive the feed stream and to produce a mixed gas stream containing hydrogen gas and other gases therefrom.

75. The fuel processor of claim 67, wherein the at least one cartridge-based component includes a bed containing a reforming catalyst.
